(19) United States
(12) Patent Application Publication
(10) Pub. No.: US 2013/0195746 A1
(43) Pub. Date: Aug. 1, 2013

(54) METHOD AND SYSTEM FOR PRODUCTION OF SILICON AND DEVICIES

(71) Applicant: Xi Chu, Mounds View, MN (US)

(72) Inventor: Xi Chu, Mounds View, MN (US)

(21) Appl. No.: 13/751,090

(22) Filed: Jan. 27, 2013

Related U.S. Application Data
(60) Provisional application No. 61/632,663, filed on Jan. 28, 2012.

(51) Int. Cl. C01B 33/039

(52) U.S. Cl. CPC C01B 33/039
USPC 423/347; 423/324; 422/187; 422/146; 422/140

(57) ABSTRACT

In one embodiment of the invention, the silane and hydrogen (and inert gas) mixture is produced using catalytic gasification of silicon (or si-containing compounds including silicon alloys) with a hydrogen source such as hydrogen gas, atomic hydrogen and proton. By not separating silane from hydrogen and co-purifying all the gases (silane and hydrogen, inert gas) in the gas mixture simultaneously, the mixture is co-purified and then provide feed stock for downstream application without further diluting the silane gas. One aspect of the invention addresses the need for an improved production method, apparatus and composition for silane gas mixtures for large scale low cost manufacturing of high purity silicon and distributed on-site turnkey applications including but not limited to the manufacture of semiconductor integrated circuits, photovoltaic solar cells, LCD-flat panels and other electronic devices. Thus, various embodiments of the invention can greatly reduce the cost and simplify the process of manufacturing silicon.

### RELATED APPLICATIONS

This application claims the benefit of priority, under 35 U.S.C. §119(e) to U.S. Provisional Patent Application Ser. No. 61/632,663, filed on Jan. 28, 2012, entitled METHODS AND SYSTEMS FOR THE PRODUCTION OF SILICON AND DEVICES, and is a continuation application of prior U.S. patent application entitled REACTOR AND METHOD FOR CONVERTING SILICON GAS filed on Jan. 19, 2012 based on International Application Number PCT/CN2010/075252 filed on Jul. 19, 2010; which the international patent application claims the benefit of priority, under 35 U.S.C. §119 to Chinese Patent Application Serial Number 200910159609.2, filed on Jul. 19, 2009; and Chinese Patent Application Serial Number 200910166276.6, filed on Aug. 8, 2009, the entire contents of which are incorporated herein by reference in their entirety.

### FIELD OF THE INVENTION

The present invention relates to a process method, composition and system for catalytic gasification of silicon materials including elemental silicon, silicon alloys and si-containing compounds by hydrogen sources such as hydrogen gas, ion (proton) and atomic hydrogen to form a silane mixture. The mixture is then co-purified to leave only silane, hydrogen and inert gas for the production of high purity silicon and silicon containing devices.

### BACKGROUND OF THE INVENTION

Silane, especially monosilane (SiH₄) gas is increasingly used in the manufacture of polysilicon, electronic devices such as integrated circuits (ICs), liquid crystal display (LCDs), and solar cells. Since it was first synthesized 150 years ago, more than a dozen techniques have been developed to produce silane; most of which involve complicated processes and dangerous chemicals.

U.S. Pat. No. 3,043,664 Production of Pure Silane, by Mason, Robert W. Kelly, Donald H. and U.S. Pat. No. 4,407,783 Producing Silane from Silicon Tetrafluoride, Oct. 4, 1983 by Ulmer, Harry E. et al teach the production of silane SiH₄ using tetrahalosilanes (such as SiCl₄ and SiF₄) and hydrides such as LiH, NaH, or LiAlH₄.

In addition, in U.S. Pat. No. 4,755,201 U.S. Pat. No. 5,499,506, U.S. Pat. No. 6,942,844, U.S. Pat. No. 6,905,576, U.S. Pat. No. 6,852,301, and U.S. Pat. No. 8,105,564, a production process commercialized by Union Carbide during the 1980s is disclosed. In this process, metallurgical grade silicon (Met-Si), hydrogen and silicon tetrachloride (STC) are reacted at around 500° C. and 30 atms with copper as catalyst to form trichloride silane (TCS), TCS is then catalytically converted into dichloride silane (DCS) and STC, and DCS is further redistributed into silane over an anion-exchange resin catalyst.

Ideally, silane is produced by hydrogenation of silicon. However, the direct reaction between silicon and hydrogen is thermodynamically unfavorable except at ultra-high temperatures and ultra-high pressures (up to 2000° C. and 1000 atms). Another challenge is, at a high temperature greater than 300° C., silane tends to decompose back into silicon fine soots and hydrogen making the production yield extremely low. So far not a single successful experiment on this approach has been reported yet.

In addition, all other processes focus on producing ultra-high pure silane (99.9999%) by tedious and energy extensive separation and purification processes, while also neglecting the end need for silane in real commercial applications is either a mixture of silane and hydrogen and/or inert gas in the range from a few parts per million (ppm) to 99%, i.e. Silane must be diluted with hydrogen or inert gas such as argon or helium in order to be used in specific applications.

### SUMMARY OF THE INVENTION

In one embodiment of the invention, silane and hydrogen (optionally with inert gas) mixtures are produced using catalytic gasification of Si-materials including elemental silicon, silicon alloys and Si-containing compounds with a hydrogen source such as hydrogen gas, atomic hydrogen and/or hydrogen ions (proton). With the presence of catalyst, the reaction temperature can be greatly reduced and the reaction rate of silane formation can be enhanced. The gas mixtures (silane and hydrogen, with inert gas) may be co-purified simultaneously to remove phosphor (P) and boron (B) compounds and other harmful impurities (without separating silane from hydrogen or inert gas). The co-purified mixture is then fed for downstream applications. This can greatly reduce the cost of, and simplify the manufacturing process of silane thus the down stream applications.

One aspect of the invention addresses the need for an improved production method for silane gas mixtures for large scale low cost manufacturing and distributed on-site on-demand turnkey applications. These applications include but are not limited to the manufacture of high purity polysilicon, semiconductor devices such as integrated circuits, photovoltaic solar cells, LCD-flat panels and other electronic devices. This can greatly reduce the cost and simplify the process of manufacturing silicon and semiconductor devices.

One embodiment of the invention provides a method for producing silicon, comprising:
a) producing silane, hydrogen and inert gas mixture by catalytic gasification of Si-Material including elemental silicon, silicon alloys and si-containing compounds with a catalyst and hydrogen sources;
b) quenching the gas mixture right after the reaction to avoid the decomposition of silane;
c) co-purifying silane, hydrogen and inert gas;
d) producing silicon using purified silane mixture;
e) recycling the hydrogen and the inert gas from step d) and returning to step a); and
f) Recovering and recycling the catalyst and returning to step a).

Another embodiment provides hydrogen sources that are selected from hydrogen gas, atomic hydrogen and ionic hydrogen. The catalyst is selected from the group consisting of:

a) noble metals, especially, Pd, Pt, Rh, Re, Ru, and the alloys thereof;
b) transition metals, especially, Ni, Cu, Co Fe, and the alloys thereof;
c) alkali metals, especially, Na, K, Li, Ca and the alloys thereof;
d) rare earth metals;
e) metal salts; metal compound such as oxide, and
f) metal hydrides

The silicon alloy is selected from one or a combination of silicon with alkali metals, alkali earth metals, transition metals, rare earth metals, and low meting point metals, especially, Si— (Li, Na, K, Ns, Be, Mg, Ca, Sr, Ba, Al, Ga, In, Tl, K, and Fe) in the forms of slab, bulk, rod, granule, powder, melts, suspension in liquid, and gas phase vapor.

The gasification agent is selected from one or a combination of

a) hydrogen (or D₂) gas;
b) hydrogen ions in acids or metal hydride or dissociate acids;
c) hydrogen ion generated by electrochemical cell; and
d) atomic hydrogen generated by plasma gasification

Another embodiment provides atomic hydrogen comprising of DC Plasma, microwave; radio frequency (RF), hot wire and glowing discharge.

Another embodiment provides quenching as a rapid heat exchange with cooling media of pre-produced silane mixture itself or a rapid pressure drop of the produced gas mixture.

The other embodiment of the invention provides a system for the production of silane, comprising:

A reaction chamber;
A hydrogen source to gasify silicon and alloys such as atomic hydrogen by plasma and hydrogen ion by electrochemical cells;
Means of supplying hydrogen sources and silicon sources to the reactor chamber;
Means of supplying Si-material (silicon, alloys, and si-containing compounds) in the chamber in the form of an ingot, a rod, a stream of powder, melt, vapor, suspension in a liquid or molten salts, and any form of solid, liquid melt, slurry, paste or vapor;
Means of loading the catalyst to silicon and alloys;
Means of quenching the gas existing in the said reaction chamber;
Means of co-purifying the silane mixture after quenching of the product gas mixture; and optionally
Means of recycling catalyst and hydrogen and inert gas recovered in the process at the end of the process.
Another embodiment provides the reaction chamber that is selected from packed bed, spouted bed, fluidized bed, moving bed of the silicon powder, and stirred bed or ticking bed for the melt. The reaction chamber has conditions of:
Temperature: −30-3000° C., 200-3000 C., 300-3000 C., 500-3000 C., 500-2000 C., or 500 C.-1500 C.; Pressure: 0.001-1000 Mpa; Input gas hydrogen in inert gas: 1-99.99999%; Output gas: silane in hydrogen 0.5-99%; and
Residence time of gases: 0.001 to 1000 secs.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

Unless explicitly stated, the method embodiments described herein are not constrained to a particular order or sequence. Some of the described embodiments or elements thereof can occur or be performed at the same point in time.

### BRIEF DESCRIPTION OF DRAWINGS

FIG. 1 shows the process flow diagram of one embodiment of the invention for the production of high purity polysilicon starting from low purity metallurgical silicon.

FIG. 2 shows the process flow diagram of one embodiment of the invention for the production of premixed silane for distributed on-site turn-key applications starting from high purity silicon.

FIG. 3 shows a multistage fluidized-hybrid chemical gasification reactor.

FIG. 4 shows another multi-stage moving bed chemical gasification reactor.

FIG. 5a shows the schematic of a high temperature high pressure gasification reactor.

FIG. 5b shows the silane flame with distinguish orange color comes out of a catalytic gasification reactor using hydrogen.

FIG. 6 shows a reactor combining RF plasma atomic hydrogen generating and silicon gasification into a single unit.

FIG. 7 shows a scanning electron micrograph of an etched silicon single crystal surface by Pd catalyst particles after heating in hydrogen at 900° C. for 30 minutes.

FIG. 8 shows an amplified micrograph of the same etched silicon single crystal surface of FIG. 7 showing a wedged channel created by the motion of a catalyst particle.

### DETAILED DESCRIPTION

### Definition

The below are the terminology definitions of materials, method, and equipment employed in the embodiments of the current invention:

Metals: are those listed in the periodic table with the symbols of:

Alkali and alkaline earth metals: alkali metals and the alkaline earth metals: lithium (Li), sodium (Na), potassium (K), rubidium (Rb), cesium (Cs), and francium (Fr), beryllium (Be), magnesium (Mg), calcium (Ca), strontium (Sr), barium (Ba), and radium (Ra);

Transition metals: Scandium (Sc), Niobium (Nb), technetium (Tc), Hafnium (Hf), Mercury (Hg), Actinum (Ac), rutherfordium (Rf), Dubnium (Db) Seaborgium (Sg), Bohrium (Bh), Hassium (Hs), Meiterium (Mt), Damstadtium (Ds), Roentgenium (Rg), Copernicium (Cn), Cadmium (Cd), Chromium (Cr), Cobalt (Co), Copper (Cu), Hafnium, Iron (Fe), Magnesium (Mn), Molybdenum (Mo), Nickel (Ni), Niobium, Selenium, Tantalum (Ta), Titanium (Ti), Tungsten (W), Uranium (U), Vanadium (V), Zinc (Zn), and Zirconium (Zr);

Noble metals: Silver (Ag), Rhenium (Re), Osnium (Os), Irredium (Ir), Gold (Au), Palladium (Pd), Platinum (Pt), Rhodium (Rh), and Ruthenium (Ru);

Low melting point metals: Aluminium (Al), Gallium (Ga), Indium (In), Thalium (Tl), Germanium (Ge), Tin (Sn), Lead (Pb), Antimony (Sb), Bismuth (Bi), Polonium (Po) and Tellurium (Te);

Rare earth metals: Lanthanide Series (Yittrium (Y), Lanthanum (La), Cerium (Ce), Praseodymium (Pr), Neodymium (Nd), Promethium (Pm), Samarium (Sm), Europium (Eu), Gadolinium (Gd) Terbium (Tb), Dysprosium (Dy), Holmium (Ho), Erbium (Er), Thulium (Tm), Ytterbium (Yb), Lutetium (Lu); Actinide Series Actinium, Thorium (Th), Protactinium (Pa), Uranium (U), Neptunium (Np), Plutonium (Pu), Americium (Am) Curium (Cm), Berkelium (Bk), Californium (Cf), Einsteinium (Es), Fermium (Fm), Mendelevium (Md), Nobelium (No) and Lawrencium (Lr).

Si-materials: one or a combination of elemental silicon, silicon alloys, and Si-compounds:

elemental silicon: metallurgical silicon, polysilicon, single crystal silicon, Various existing engineering methods can be chosen to make silicon and silicon alloys in the form of ingot, bulk piece, sheet, rod, granules, or powder.
silicon alloys: can be formed as Si-Mx, where M is one or more of the alkali and alkaline earth metals, transition metal, noble metals, rare earth metal, and low-melting point metals defined above, especially the following elements: Li, Be, Na, Mg, Al, K, Ca, Cr, Mn, Fe, Co, Ni, Cu, Zn, and where x is from 0.01 wt % to 95 wt %. The alloys can be in the form of ingot, bulk piece, sheet, rod, granules, powder, melt, and vapor.

The si-containing compounds: any material that contains silicon but not elemental silicon or silicon alloys, such as oxides (SiO, SiO₂), nitride, carbide, hydrides, salts and ceramic.

The Si-material can be in solid (in the form of an ingot, a rod, a stream of powder), liquid melts, and vapor form by itself. It can be added into solution, molten salts matrix as a mixture, suspension, slurry, or paste.

Hydrogen sources: also referred to herein as hydrogen gasification source, is one or a combination of:
a) hydrogen gas including (isotope of hydrogen);
b) hydrogen ions (proton) in dissociate inorganic and organic acids such as HCl, HF, H₂SO₄, HNO₃, H₃PO₄, H₂CO₃, H₄SiO₄, acetic acid, or bases NH₄OH, and salt NH₄Cl, NH₄F, NH₄NO₃, (NH₄)₂SO₄, (NH₄)₃PO₄, (NH₄) 2CO₃, (NH₄)₄SiO₄, etc
c) metal hydride (LiH, NaH, KH, NaAlH₄NaLiH₄ NaAlH₄NaAlH₄NaAlH₄ NaAlH₄, etc)
d) hydrogen ion generated by electrochemical cells employing, aquious, organic, molten, polymer, and solid ceramic electrolytes.
e) atomic hydrogen generated by hydrogen plasma created by Microwave, RF, DC, Glowing, and hot-wire.

Catalyst and promoter: is one member or any combination selected from the following groups:
a) Metals defined above, especially, noble and transition metals;
b) alkali metals and the alkaline earth metals: lithium (Li), sodium (Na), potassium (K), rubidium (Rb), caesium (Cs), and francium (Fr) group 2 elements. beryllium (Be), magnesium (Mg), calcium (Ca), strontium (Sr), barium (Ba), and radium (Ra).
c) Rare earth metal: Lanthanide Series Lanthanum, Cerium, Praseodymium, Neodymium, Promethium, Samarium, Europium, Gadolinium Terbium, Dysprosium, Holmium, Erbium, Thulium, Ytterbium, Lutetium; Actinide Series Actinium, Thorium, Protactinium, Uranium, Neptunium, Plutonium, Americium Curium, Berkelium, Californium, Einsteinium, Fermium, Mendelevium, Nobelium, Lawrencium.
d) Group III-VI metal
e) alloys hydrides, and
f) metal compounds such as oxides, organic and inorganic salts of the metal elements set forth above in this Catalyst and Promoter section.

Catalyst preparation and loading: Provided that catalyst can be widely dispersed on the Si-material that is in direct contact with hydrogen gasification sources. In one embodiment of the invention, catalyst can be added into silicon when it is metallurgically produced similar to alloying or added during the grinding process, or even loaded to the surface of the final granules from solution, provided the catalyst can be uniformly distributed. The loading of catalyst can be from 0.0001 wt % to 80 wt % depending on the nature of the silicon and alloy materials. For example, for silicon ingot, 0.0001 wt % of catalyst can be added to the surface, but for fine silicon powders, since they have a large specific surface area, as much as 20 wt % of catalyst should be present to cover all the surface. Furthermore, catalyst can be recovered from the gasification reactor unit and returned into the catalyst loading/raw material preparation unit.

Catalytic reaction: chemical reaction accelerated by the presence of a catalyst or promoter, the catalyst is not converted into the desirable product of the reaction.

Si-material catalytic gasification: reaction between Si-material and hydrogen source with the presence of a catalyst under elevated temperature and pressure depending on the nature of the combination. However, the reaction products contain at least one si-containing gas phase product when returned to ambient condition.

Silane: silicon-hydrogen compounds with a formulation of SixHy; wherein x is an integer including x=1, 2. 3, 4, 5, −100; y=x, 2x, or 2x+2. Monosilane SiH₄ is the most common form of the silane. Silane can also be in the form of SixDyHz, wherein D is an isotope of hydrogen, x is an integer of 1, 2. 3, 4, 5, −100; (y+z)=x, 2x, or 2x+2.

Silane co-purification: a process used to obtain a high purity gas or gas mixture including one or any mixture of silane, hydrogen, and inert or non-reacting gas such as He, Ne, Ar, Kr, Xe, Rn, N₂, H₂, D₂ up to 99.99% purity or above (with silane composition from 1 ppm to 99% by weight, the rest are hydrogen and inert gas), other impurities each no more than 1 part per million (ppm).

Co-purified silane mixture: contains silane, hydrogen, and inert and non-reacting gas such as He, Ar, N₂, with purity of the each component and the total mixture being up to 99.99% and above (with silane composition from 1 ppm to 99%, the rest are hydrogen and inert gas), other impurities each no more than 1 part per million (ppm).

Quench: rapidly cool the reaction product to temperature below 600° C. in 10 seconds or less once the gas or gas mixture leave the gasification chamber to avoid the decomposition of silane.

Silane mixture co-purification: silane is not separated from hydrogen, and inert gas such as He, Ar, but other impurities, especially the most harmful impurities boron (B) and phosphor (P) compounds are removed to a level below 1.0 PPm in the purified silane mixture.

Silicon production: production of silicon with a purity greater than 99.99% using silan mixture; the form of silicon can be ingot, liquid, granules prepared by Siemens technique, vapor to liquid, or a centralized flow-bed granular polysilicon production system respectively.

Silicon device production: device containing si-element that can be produced using silane such as semiconductor devices such as integrated circuits, photovoltaic solar cells, LCD-flat panels and other electronic devices.

### Part A) Process Method, Reaction Parameters and Reactor

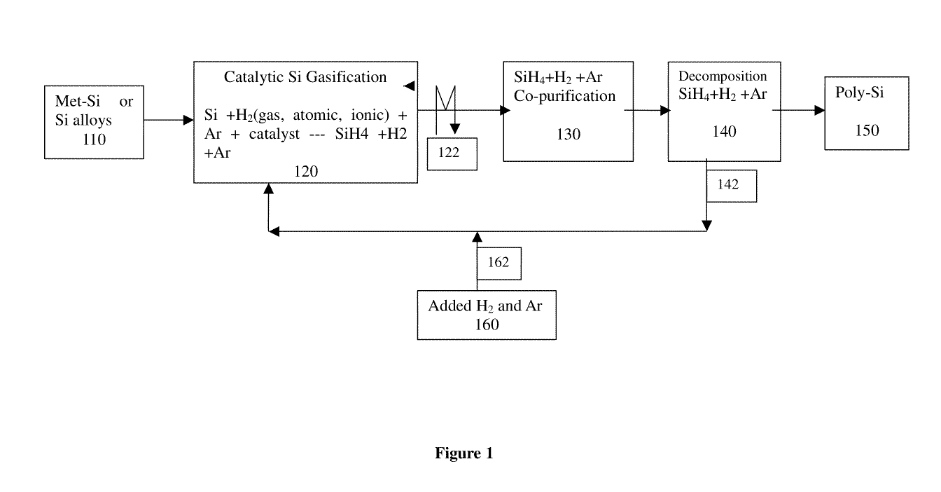

As shown in FIG. 1 is a non-limiting example, metallurgical silicon or silicon alloys loaded with catalyst from unit 110 is gasified through gasification unit 120 using hydrogen gas, hydrogen ions generated by electrochemical cells or atomic hydrogen by a plasma process at elevated gasification temperature to form silane and hydrogen (or inert gas argon) mixtures. The mixture may be rapidly cooled down (quenched) from reaction temperature to 300° C. or below immediately once it exits the gasification unit by heat exchanger 122 to avoid the decomposition of the formed silane.

After quenching, the mixture may be purified in unit 130. This unit 130 will not separate hydrogen and argon from silane, but rather co-purify with them to remove other impurities, especially the boron (B) and phosphor (P) compounds. The purified silane mixture will be used for down stream applications such as polysilicon production shown in unit 150, wherein the polysilicon production unit 150 is a centralized flow-bed granular polysilicon, or vapor to liquid, or Siemens reactor system in which silane is converted into high purity polysilicon and hydrogen by-product. Hydrogen and argon byproduct from the end polysilicon production unit 150 can be recovered and recycled to the gasification unit illustrated by arrow 142. Hydrogen and argon can be added through unit 160 to make up the process loss as shown by the arrow 162. The catalyst is recovered at the bottom of the gasification unit and returned to the silicon or si-containing compounds including silicon alloy catalyst loading unit (not showing).

Silane is currently widely used in the production of semiconductor devices such as integrated circuits, photovoltaic solar cells, LCD-flat panels and other electronic devices. Ultra-pure silane (99.9999%) in bulk tank is shipped to re-bottling facilities, thousand miles away to be refilled in small cylinders (10 kg or less each). The silane cylinders will be shipped to application sites such as a semiconductor Fab to be diluted with hydrogen or argon as a silane gas mixture with silane composition from a few ppm to about 99% for various chemical vapor deposition applications. This handling process is expensive and dangerous since silane is a high explosive gas. Therefore, a on-site on-demand distributed silane source would provide improvements to many industries.

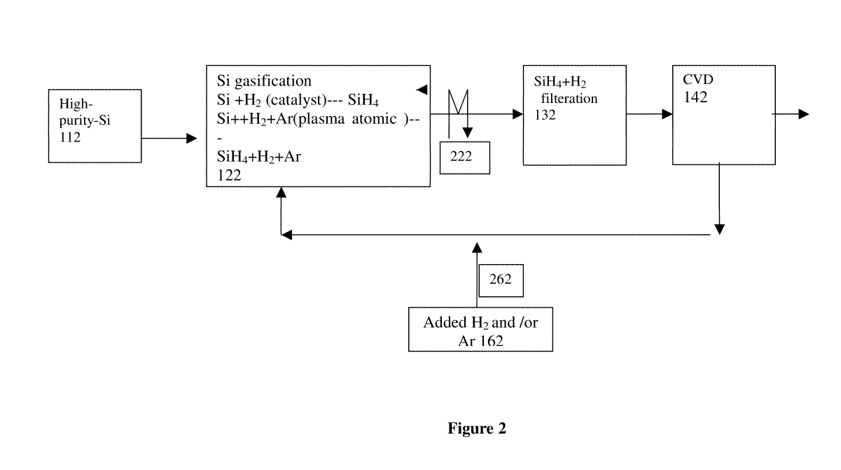

FIG. 2 shows an exemplary process flow diagram according to one embodiment of the invention for the production of premixed silane for distributed on-site on-demand turnkey applications starting from high purity silicon and high purity hydrogen sources. As shown in FIG. 2, ultra-pure silicon is used as starting material and is catalytic gasified through gasification unit 122 using hydrogen gas or atomic hydrogen generated by plasma to form a silane and hydrogen (or inert gas argon) mixture. The hydrogen plasma is, preferably, activated by radio frequency (RF) or microwave to avoid possible contamination such as those caused by electrode erosion in a DC plasma.

The mixture will be quenched by heat exchanger 123 to avoid silane decomposition as stated above. After quenching, the mixture will be purified in unit 132, unit 132 will not separate hydrogen and argon from silane, but rather co-purify with them to remove impurities other than them. The purified silane mixture will be used for down stream CVD 142 device applications such as ICs and solar cell production shown in unit 152. Hydrogen and argon can be recycled and returned to the gasification unit. hydrogen and Ar can also be added through unit 162 via 163 if needed. The composition in unit 142 could be further adjusted by external silane or H₂ through unit 162 depending on specific silane concentration situation. There is no extensive purification steps, only filtration of the gas mixture, if needed external dilution is added, in the whole process.

### Gasification Process and Reactor Construction

### Raw Materials

Any Si-material can be used as starting material. In one embodiment of the invention for the catalytic gasification to form silane mixture for polysilicon production as shown in FIG. 1, metallurgical silicon and silicon alloy are good starting raw materials. For distributed on-site on-demand silane application as shown in FIG. 2, undoped single crystal or polycrystalline silicon can be used as raw starting material.

### Catalyst Composition and Loading:

Catalyst can be at least one element chosen from the following groups:

a) noble metals, especially, Pd, Pt, Rh, Re etc,
b) transition metals, especially, Ni, Cu, Co, Fe etc,
c) alkali metals, especially Na, K, Li, Ca, etc,
d) Rare earth metals
e) Group III-VI metal
f) metal alloys,
g) hydrides, and
h) metal compounds: oxides, chlorides and organic and inorganic salts.

Catalyst can be added into silicon when it is metallurgically produced similar to alloying or added during the grinding process, or even loaded to the surface of the final granules from solution, provided the catalyst can be uniformly distributed. The loading of catalyst can be from 0.0001 to 80 wt % depending on the nature of the silicon and alloy materials. For example, for silicon ingot, 0.0001 wt % of catalyst can be added to the surface, but for fine silicon powders, since they have a large specific surface area, as much as 20 wt % of catalyst should be present to cover all the surface. Furthermore, catalyst can be recovered from the gasification reactor unit and returned into the catalyst loading/raw material preparation unit.

### Hydrogen Gasification Sources:

The gasification agent is selected from one or a combination of:
a) hydrogen gas (or iotrope of hydrogen);
b) hydrogen ions (proton) in acids or metal hydride (LiH, NaAlH₄, etc) or dissociate acids such as HCl, HF, H₂SO₄, H₃PO₄, H₄SiO₄, acetic etc salts: NH₄Cl,
c) hydrogen ion generated by electrochemical cell; and
d) atomic hydrogen generated by plasma gasification

### Gasification Reactor Type:

Depending on the type of silicon raw material, and the gasification hydrogen sources, the reactor type can be chosen from either a packed bed, spouted bed, fluidized bed, moving bed or their combination of the silicon powders or granules. The following table shows the reaction parameters of catalytic gasification of silicon.

TABLE 1
Reaction conditions for silane production using catalytic gasification:

| Reaction parameter | Lower bound | Higher bound |
|---|---|---|
| Temperature (° C.) | −30 | 3000 |
| Pressure (Mpa) | 0.1- | 1000 |
| Residue time (secs) | 0.001 | 1000 |
| Catalyst loading (wt %) | 0.0001 | 80 |
| Input gas composition_{—} | 1.0 | 99.9999 |
| hydrogen in inert gas (%) | | |
| Output gas composition silane | 0.00001 | 99.9999 |
| in hydrogen (%) | | |

From the thermodynamic point of view, the higher the temperature and pressure, the higher the conversion. However, the process of economics should be considered; the pressure and temperature should be optimized to achieve the best results and the manufacturability. High temperature and pressure also increase the capital cost at high temperature, and the decomposition of silane is also of critical important to be avoided. The silicon and alloys thus could be in a solid, liquid or even gas phase during the specified temperature range.

The heating of the reactor could be performed by internal heating through inducted heating, electric heating, or combustion heating etc. The heating unit can be installed internally or externally on the reactor chamber. Reactants have to be heated in order to achieve the reaction temperature. The heating unit is preferably selected from the electrical connection of the power supply with high granular silicon bed layer, i.e., the bed layer of high purity granular silicon is applied with voltage. Due to the semiconductor properties of silicon, the high purity granular silicon bed layer is heated and the temperature is increased. Such methods provide direct heating, high thermal efficiency, and high utilization efficiency. It can also help to prevent pollution and ensure the purity of the product. The heating unit can also be many other existing heating technologies including:
1) direct heating using resistance wire (silicon ingots, high purity SiC, high purity SiN, or high purity graphite and other materials);
2) indirect heating by microwave, plasma, laser or induction and other methods;
3) indirect heat radiation from the flame across the combustion tube that can provide heating or rotary kiln;
4) using outer jacket and internal bed heating exchanger, the outer jacket heat exchanger can be used outside the jacket and the heat carrier heating inductor converter; bed heat transfer can be by heat induction, electrical induction, and electrode heating, etc.;
5) external heating methods, such as the reactants required in the reaction (e.g., suspended gas and silicon particles itself) are heated externally before introduced into the reactor;
6) Dual-formed reaction heat (coupling-reaction heating) by chemical reaction, such as chlorine (Cl₂) or hydrogen chloride (HCl) are added to the system.

### Catalytic Gasification Using Hydrogen Gas

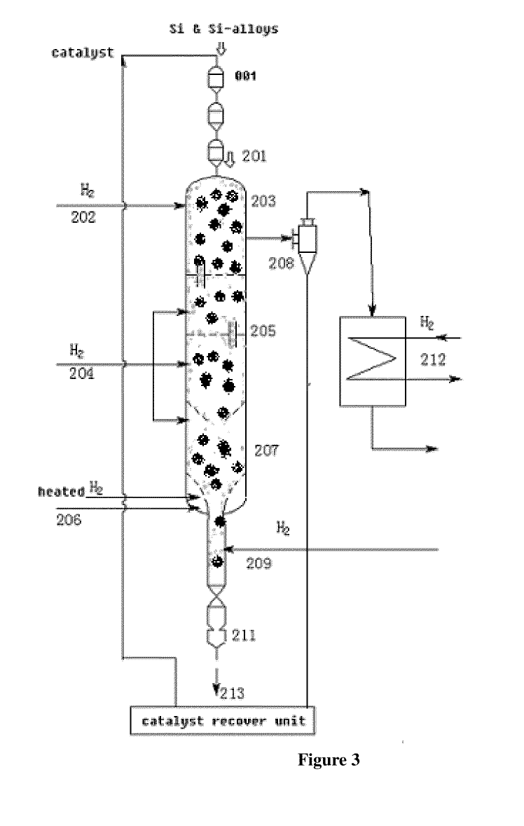

As shown in FIG. 3, Si-material (elemental silicon or si-containing compounds including silicon alloy) granules pre-loaded with catalyst may be introduced into a catalyst loading mixer 001, After been well mixed, the silicon will be introduced, via the feeding system 201, into the first reaction zone 203 on the top of the reactor chamber. Since the gasification is conducted at high temperature under high pressure with the presence of hydrogen, the silicon granule and powder feeding system can be constructed with a series of interconnected multiple chambers to gradually increase the system pressure.

The first reaction zone 203 is a packed bed, with the materials (silicon or alloy) supported by a porous plate with a side hole for passing silicon to the next reaction zone below, the resulting gas mixture of gasification taken place underneath the plate is allowed to pass through the packed bed in zone 203 to capture dust formed from the reaction, and to preheat the silicon bed. The gas mixture was further de-dusted in a solid gas separator 208 down stream and then quenched, preferably below 300° C., by a heat exchanger 212 to avoid the decomposition of silane in the gas mixture.

In order to ensure the solid-gas reaction rate, the mid-section, the second reaction zone 205 of the reactor chamber is constructed as a fluidized bed reaction zone.

In the third reaction zone 207, two (two or more) fluidized reaction segments can be formed by the gas mixture from the lower reaction zone. The arrangement at the reaction zone can ensure the max conversion and yield.

In one embodiment of this invention, gasification hydrogen sources can be added into the reaction chamber at several locations. Specifically, hydrogen sources can be added into the reaction zone 203 through port 202 to cool down the temperature of silane to avoid the decomposition, through port 204 to balance the gas flow so the fluidization in zone 205 can be stabilized.

The primary gasification hydrogen sources can be preheated and added through port 206 at the bottom of the reactor chamber, it reacts with silicon in reaction zone 207, the resulting product mixture then travels upward to pass reaction 205 and 203 and finally through 208 down to stream treatment.

On the other hand, some silicon particles travel downward by passing through reaction zone 203, 205 and 207 sequentially, Finally, the remains will fill into 209 and be collected by 211. The remains contain mostly ungasified catalyst component and is recovered by 213, a catalyst recover unit, and then is returned to mix with the incoming silicon or alloy powder, or recycled to the catalyst loading process for the preparation of silicon and alloy raw materials.

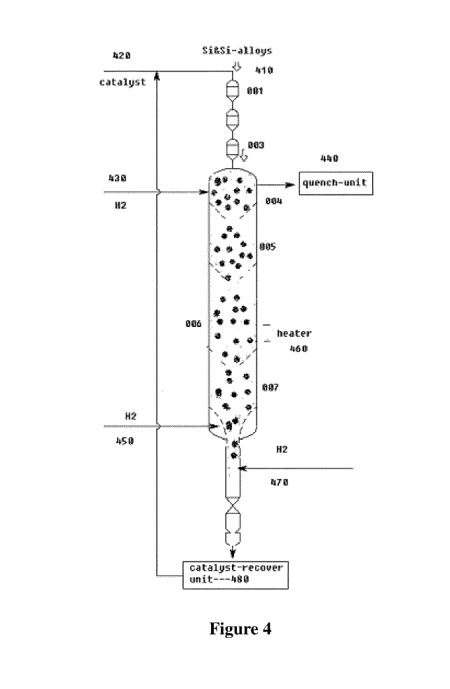

FIG. 4 shows another embodiment of the invention, a multi-stage moving bed chemical gasification reactor. The reaction chamber is divided into several segments by conical shaped gas distributors, and the four moving bed reaction zones are connected in series. During the reaction, silicon particles from 410 along with recovered catalyst and added catalyst travel downward to mixer bin 001, then into reaction chamber.

Silicon particles travels downward by passing through reaction zone 004, 005, 006 and 007 sequentially and the particle size should be gradually reduced due to gasification, Finally, the remains will fill into and collected by 480 a catalyst recover unit. The remains contain mostly catalyst component and is recovered by 213, and then is returned to mix with the incoming silicon or alloy powder, or recycled to the catalyst loading process for the preparation of silicon and alloy raw materials.

The gasification hydrogen sources can be introduced through port 430, 450, and 470 respectively, the resulting gas mixtures travel upwards for each segment and then are forced into redistribution into another bed above. This avoids the tunneling of gas in the deep bed, ensures even and complete contact of the gas and solid silicon particle surface during reaction. The final gas mixture can be rapidly cooled dawn once it leaves the reactor chamber by quench unit 440 to avoid the silane decomposition.

Since high temperature and pressure favor silicon gasification, while hydrogen can cause metal enbrittlement at high temperature, thus reduces the mechanical strength. therefore, internal heating may be adapted, meanwhile insulation linear to the inner surface of the reactor wall may be chosen to keep the reactor wall at a relatively low temperature to sustain high gasification pressure.

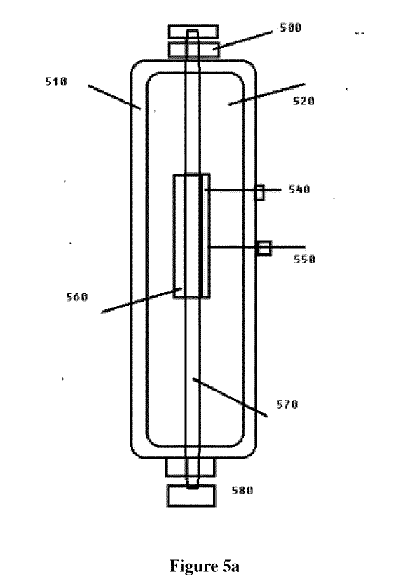

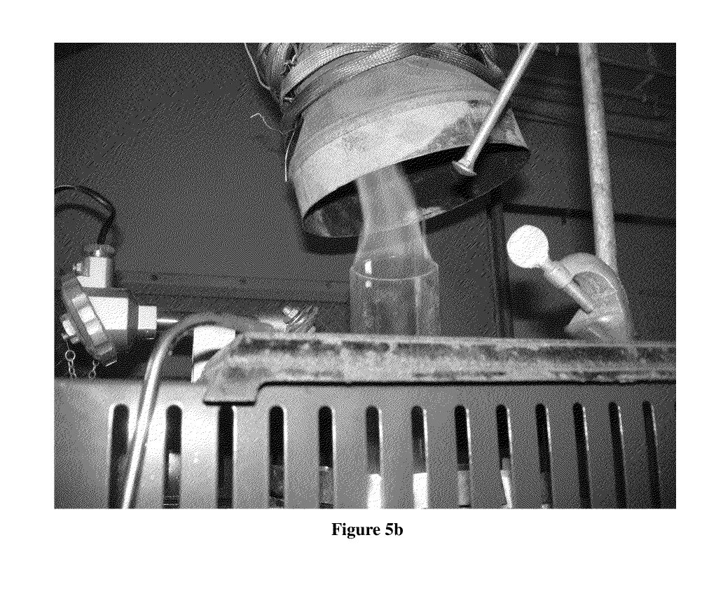

FIG. 5a shows the schematic of internal structure of one embodiment of the gasification reactor employed in this invention. The reactor chamber 570 is surrounded by heating element 560. The power supply for heating unit is provide through pressure proof connector 540. The temperature of the reactor is monitored through a thermal couple that is inserted through prot 550. The reactor chamber and the heating unit 560 are all been separated by insulation layer 520 from the outer shell 510 of the reactor. During gasification, the hydrogen source enters into the reactor through 500 and the formed gas mixture exit from 580 and is rapidly cooled down.

### Catalytic Gasification Using Protons Generated by an Electrochemical Production Cell

Hydrogenation of chemical by hydrogen ion (proton) is more reactive as compared with hydrogen gas, especially under the action of a electro-potential. Hydrogen ion (proton) can be generated using an electrochemical reaction chamber or cell containing electrolyte, anode and cathode and is well known in the art. In one embodiment of this invention, the following method of electrochemical construction can generate hydrogen ions to further enhance the silicon gasification to form silane:

### Hydrogen Electrode:

Noble metals Pd, Pt, Rh, Re etc, transition metals Ti, Ni, Cu, Co, Fe etc, alkali metals Na, K, Li etc, metal alloys formed as high surface area porous structure either by themselves or loaded on a conducting matrix. The electrode should be in contact with and uniformly distribute incoming hydrogen gas and well wet with the electrolyte.

### Si-Material Electrode (Elemental Silicon, Si-Alloy and Si-Containing Compounds):

Packed bed, spouted bed, fluidized bed moving bed of the silicon powder, granules, and solid pieces or paste or slurry with catalyst can be chosen as actual electrode chamber. In addition, since silicon and alloys are consumed during the course of the reaction, it should be necessary to supply silicon into the electrode chamber, whether in the form of a silicon granules, sheet, a silicon rod, a stream of silicon powder (which should increase the reaction rate) or any other appropriate form of solid, paste, or slurry) and contains catalysts mentioned in the previous section.

### Electrolyte and Proton Exchange Membrane:

The electrolyte could be liquid, high voltage electrolyte, especially nonaqueous proton, molten salt, or polymer-based gel electrolyte and even high temperature solid ceramic electrolyte capable of transporting proton during the gasification processes.

### Catalytic Gasification by Atomic Hydrogen

Hydrogen plasma has been used to etch a silicon surface, either for preparation of the surface prior to deposition, or for preferential etching of certain surfaces, while others are protected from the etching process by an oxide layer, for the purpose of creating devices on a silicon wafer. It is well known that atomic hydrogen favors the hydrogenation reaction. However, atomic hydrogen can only be generated under certain condition such as ultrahigh temperature or under electro arc or high frequency electro-magnetic stimulation. To activate the formation of hydrogen plasma, inert gas such as Ar and He is usually added into the system to initiate the hydrogen plasma. The atomic hydrogen form is of short lifetime in general and the concentration of atomic hydrogen and the contacting time with silicon surface are key factors in a hydrogen plasma chemical reaction. The silicon gasification reactor should combine the atomic hydrogen generation and in immediate contact with silicon. As shown in the following table, hydrogen plasma includes: DC plasma, microwave; Radio frequency, hot wire and glowing discharge etc. Accordingly, gasification reactor can be constructed using one of the following or their combination packed bed, spouted bed, fluidized bed moving bed of the silicon powder to maximize the gasification

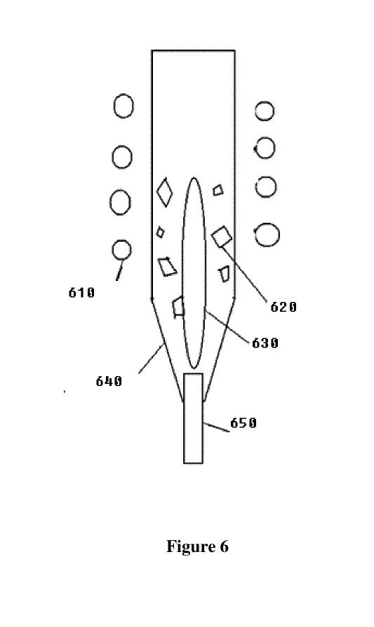

FIG. 6 shows an RF plasma atomic hydrogen silicon gasification reactor. 610 is a induction coil, 640 is the reactor chamber made from a non-magnetic refractory material such as ceramic like quartz, hydrogen gas (optionally with inert gas Ar or He) enters into the reactor chamber forming a plasma torch 630 under the RF power supplied by the induction coil 610. The silicon powder or granules 620 are circulated within the chamber by the torch until they become too small (due to gasification) to be carried out to the exit gas mixture stream. This electrode-less reactor has no contamination of electrode material erosion during operation. It is best for the on-site distributed turnkey silane application. While also, the combination of reactor type and plasma form is outlined in the following table that can be chosen from for a specific application. For example, in some embodiments, the production method of the current invention consists in producing silane gas by exposing the silicon powder to a hydrogen plasma. The silicon body is made of ultra-high purity for on-site application, while for large scale applications, metallurgical-grade silicon is used in order to minimize the cost of the end product.

### Part B) Quench of Silane Mixture

Since silane can be decomposed at a relatively low temperature, silane mixture that comes out of a high temperature reactor should be quenched as fast as possible to avoid the decomposition loss. The silane mixture that comes out of a high temperature reactor may be quenched quick to below about 500 C., 400 C., 300 C., 250 C. or lower to obtain a stable silane containing gas mixture. This could be accomplished by heat exchanging with a cooling media or by the injecting of a stream of cold hydrogen. Alternatively, when the pressure of the reactor is high, rapid pressure drop of the tail gas can lower the temperature of the gas dramatically.

### Part C) Co-Purification of Silane Mixture

Since the dilute mixture of silane and hydrogen and/or argon is used in industrial deposition such as chemical vapor deposition (CVD) for polysilicon, thin film for ICs, solar cells and LCDs etc, the subsequent separation and purification of silane from hydrogen to prepare high purity silane is not necessary, while also a waste of energy. Therefore, the silane mixture produced by said co-purified without separating impurity from silane and hydrogen is preferred.

TABLE 2
Boiling points of silane, related gases and major impurities in the
process of current invention

| | | | Molecular |
|---|---|---|---|
| | Boiling point ° C. | | weight |
| SiH₄ | −112° | C., | 32 |
| H₂ | −259 | | 2 |
| Ar | −185.85 | | 40 |
| PH₃ | −87.7° | C., | 34 |
| H₆B₂ | −92° | C. | |

For all silane related applications, the most harmful impurities are boron (B) and phosphor (P) compounds. As impurities from silicon are the primary source contributor, the major impurities of concern may be the boron hydride and phosphor hydride formed during silicon hydrogen gasification as listed in Table 2. Silane, hydrogen, and argon have a relatively low boiling point as compared with the H₆B₂ and PH₃, they can be easily separated. Beside conventional purification techniques such as distillation and condensation, the mixture could be co-purified by absorption and filtration using zeolite. Chemical adsorption and reaction agents, such alkaline compounds (include caustic, soda ash, metal oxides such CaO, MgO, Al₂O₃, . . . etc) that would selectively react with H₆B₂ and PH₃ can also be used alone or in combination with the other purification and separation process to remove H₆B₂ and PH₃. Additional purification steps can be added to the process, depending on the impurities generated, without departing from the present invention.

External addition of either silane or hydrogen can be easily carried out to adjust the composition of silane to meet specific application if needed. Alternatively by compressing the silane/hydrogen mixture, passing it through a H₂ separation membrane such as Pd, can reduce the hydrogen concentration in the silane mixture. Hydrogen recovered at each step can be recycled to the hydrogen gasification units.

### EXAMPLES

Below are several examples for the hydrogen gasification of silicon conducted according to various embodiments of the invention.

### Example 1

### Catalytic Gasification of Metallurgical Silicon Using Hydrogen Gas

2.0 wt % Cu, and 1 wt % Ni catalyst (using chlorides) is loaded onto met-silicon powder 100-30 mesh through solution impregnation or coating. After drying, silicon powder is heated in a fluidized bed reactor, a spouted bed and a packed bed reactors respectively in flow of chemical pure hydrogen at 900-1300° C. respectively. As shown in FIG. 5b, orange color flame was observed by the burning of the tail gas from the reactor indicating the formation of silane. In addition, the weight of silicon powder is noticeably reduced after 10 hours of reaction. The tail gas from the reactor is also quenched very quickly to about 500 C. or lower, or 300 C. or lower by passing the tail gas to a heat exchanger with a circulating coolant. In comparison, same amount of metallurgical silicon without catalyst is heated under the same conditions, and no mass loss of silicon is detected.

### Example 2

### Catalytic Hydrogen Gasification on the Surface of Single Crystal Silicon

To gain microscopic understanding of silicon gasification, a single crystal 100 wafer is chosen and divided into two pieces sample A and sample B respectively. A few droplets of palladium acetate solution (with acetone) is sprayed on the surface of sample A. After drying, the wafer was broken into small pieces and heated in hydrogen at various temperature for a series of time intervals. In each case, a small piece of sample B is used as a control sample. After the reaction, each sample was examined under a scanning electron microscope (SEM) for surface morphology.

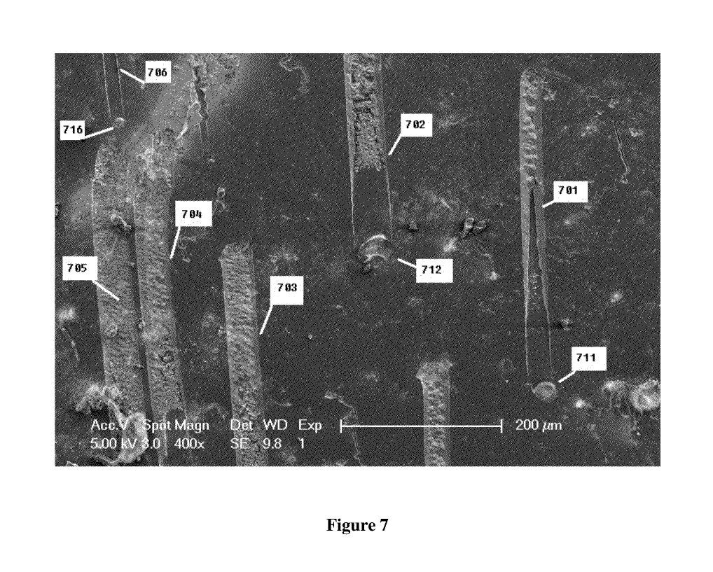

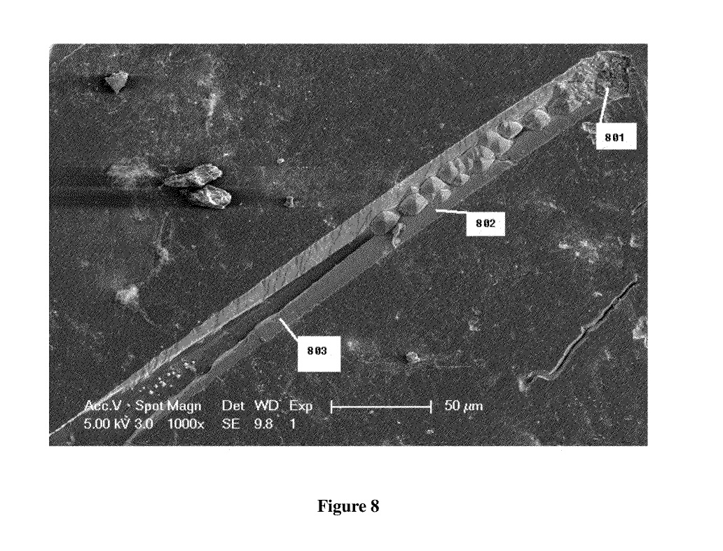

FIG. 7 shows a SEM micrograph of a Pd catalytically etched sample A single crystal surface after heating in hydrogen at 900° C. for 30 minutes. It can be seen that Pd forms catalyst particles as indicated as 711, 712, and 716, during the gasification reaction, the particles move on the single crystal surface, meanwhile they create channels (701, 702, 703, 704, 705, and 706) by facilitating the reaction between silicon and hydrogen at the catalyst and silicon interface. FIG. 8 is an amplified micrograph of the same etched single crystal surface of silicon. Channel initiation site 801, the bottom of the early formed channel 802 and the lately formed channel wall 803 are indicated in the photo.

### Example 3

Gasification of silicon by plasma generated atomic hydrogen using a commercial DC plasma torch, with hydrogen being used to form a hydrogen plasma in a fluidized bed reactor, a spouted bed and a packed bed reactors respectively generating orange color flames and golden deposit on the down stream wall indicating the formation of silane.

### Example 4

Gasification of silicon by plasma generated atomic hydrogen using a commercial ICP plasma torch, with hydrogen being used to form a hydrogen plasma in a fluidized bed reactor, a spouted bed and a packed bed reactors respectively generating orange color flames and golden deposit on the down stream wall indicating the formation of silane.

### Example 4

The hydrogen source is generated by using an Electrochemical Electrode obtained from E-TEK, Inc at 6 Mercer Road, Natick, Mass. 01760, USA; Elat/Std. Electrode with 20% Pt/C, the siliconelectrode is Met-silicon rod and Si—Ca, Si—Fe, Si Al, and Si—Mg alloys, Silane

### Example 5

Similar to Example 1 except that the gasification uses a silicon vapor evaporated using a tungsten heated graphite crucible. Silane formation is confirmed

### Example 6

Similar to Example 1 except that the gasification uses silicon particles suspension in molten salts.

### Example 7

Similar to Example 1 except that the gasification uses a silicon alloy melt with hydrogen.

### Example 8

Similar to Example 1 except that the gasification uses HCl to react with silicon alloy small particle size powder.

Other embodiments of the current invention also include process method and system for the production of silane using catalytic gasification of silicon and alloys which comprises:

A reaction chamber; packed bed, fluidized bed, spouted bed, moving bed, etc.;

A hydrogen source to gasify silicon and alloys: hydrogen gas, atomic hydrogen by plasma, and hydrogen ion by electrochemical cell; and dissocialtion of acids and hydrogen

Means of supplying hydrogen sources to the reactor chamber;

Means of loading the catalyst to silicon and alloys;

Means of supplying silicon and alloys in the chamber, whether in the form of a silicon bulk, a silicon rod, a stream of silicon powder, melt, vapor, suspension in liquid molten salts, or any other appropriate form of solid, liquid or vapor silicon;

Means of quenching the gas existing in the said reactor chamber;

Means of co-purifying the silane mixture after quenching of the product gas mixture; and optionally, means of recycling catalyst and hydrogen (inert gas) recovered in the process after the end application of silane.

An exemplary process for producing silicon comprises:
a) Providing a silicon or a Si-material, a hydrogen source comprising hydrogen or a material capable of undergoing a reaction with silicon or the si-material to form a silane, a catalyst capable of accelerating the reaction and/or lowering the reaction temperature and optionally an inert gas;
b) Producing a gas mixture comprising silane, hydrogen and an inert gas by catalytic gasification of the silicon or si-containing compound through the reaction of silicon or si-containing compound with the hydrogen source in the presence of the catalyst at an elevated temperature;
c) reducing the temperature of the gas mixture immediately after the gasification to below 500° C. to avoid the decomposition of the silane;
d) separating silane and hydrogen, and optionally an inert gas from the gas mixture to form a co-purified silane mixture with other impurities each less than 1 ppm.

The exemplary process further comprises:
e) producing silicon or a silicon device by decomposing the silane in the co-purified silane mixture and transforming the co-purified silane mixture into a reacted gas mixture comprising hydrogen;
f) returning the reacted gas mixture comprising hydrogen from step e) to step a) as a hydrogen source;
g) recovering and recycling the catalyst and return to the gasification step;

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A process for producing silicon comprising:
e) Providing a silicon or a Si-material, a hydrogen source comprising hydrogen or a material capable of undergoing a reaction with silicon or the si-material to form a silane, a catalyst capable of accelerating the reaction and/or lowering the reaction temperature and optionally an inert gas;
f) Producing a gas mixture comprising silane, hydrogen and an inert gas by catalytic gasification of the silicon or si-containing compound through the reaction of silicon or si-containing compound with the hydrogen source in the presence of the catalyst at an elevated temperature;
g) reducing the temperature of the gas mixture immediately after the gasification to below 500° C. to avoid the decomposition of the silane;
h) separating silane and hydrogen, and optionally an inert gas from the gas mixture to form a co-purified silane mixture with other impurities each less than 1 ppm.

2. The process of claim 1 further comprises:
h) producing silicon or a silicon device by decomposing the silane in the co-purified silane mixture and transforming the co-purified silane mixture into a reacted gas mixture comprising hydrogen;
i) returning the reacted gas mixture comprising hydrogen from step e) to step a) as a hydrogen source;
j) recovering and recycling the catalyst and return to the gasification step;

3. The process in claim 1, wherein the catalyst comprises at least one of: a metal, a metal alloy, a metal oxide, a metal salt, a metal hydride or a metal-containing compound; wherein the metal is selected from a group of elements consisting of noble metal elements, alkaline and alkaline earth metal elements, and transition metal elements, rare earth metal elements, and low melting point metal elements.

4. The process of claim 1, wherein the catalyst is a metal or metal alloy selected from the group consisting of noble metals, alkaline metals, and transition metals, rare earth metals, and low melting point metals.

5. The process method in claim 1, wherein si-material including at least one of elemental silicon, silicon alloy and Si-containing compounds; the silicon alloy comprising one or more of noble metal elements, alkaline and alkaline earth metal elements, and transition metal elements, rare earth metal elements, and low melting point metal elements.

6. The process of claim 1, wherein the si-material including elemental silicon, silicon alloy and Si-containing compounds comprise forms of ingot, slab, bulk, rod, granule, powder, melts, suspension in liquid, and gas phase vapor.

7. The process of claim 1, wherein the hydrogen source is one or any mixture of
e) hydrogen gas (H2 or D2, HD);
f) hydrogen ions in acids, metal hydride, or dissociate acids;
g) hydrogen ion generated by electrochemical cell; and
h) atomic hydrogen generated by (w/wo inert gas such as Ar) plasma: DC Plasma, microwave; radio frequency (RF), hot wire and glowing discharge etc. or their combination.

8. The process of claim 1, wherein the quenching of the gas mixture is conducted right after the reactor to avoid the decomposition of silane by rapid heat exchanging with cooling media of preproduced silane mixture itself or a rapid pressure drop of the produced gas mixture.

9. The process of claim 1, wherein the separating is conducted by distillation, absorption or filtration.

10. The silicon production in claim 1 wherein the polysilicon production process is a centralized flow bed granular polysilicon or vapor to liquid or Siemens reactor system.

11. The process in claim 1 wherein the application is either for large scale centralized or on-site-distributed application.

12. The catalytic gasification in claim 2, wherein the reactor types are packed bed, spouted bed, fluidized bed, moving bed of the silicon powder, or stirred bed and ticking bed for the melt.

13. The process of claim 1, wherein the reaction conditions are:
Temperature: −30-3000° C.;
Pressure: 0.001-1000 Mpa;
Input gas hydrogen in inert gas: 1-99.99999%;
Output gas: silane in hydrogen 0.5-99%;
Residence time of gases: 0.001 to 1000 seconds.

14. The process of claim 1, wherein the catalysts of the gasification is recovered and recycled to the raw material.

15. The process of claim 1, wherein the hydrogen gas and inert gas are recovered and recycled after the end application to feed into the gasification process.

16. The process of claim 1, wherein the catalyst can be loaded onto silicon and si-containing compounds including silicon alloys powder particles surface, into the melts or solutions.

17. A reactor system for producing silane mixture, comprises:
a) a gasification chamber;
b) a silicon-material feeding bin; means of supplying silicon and alloys powder in the chamber in the form of a silicon
c) a hydrogen feeding port for a hydrogen sources to be fed into the gasification chamber
d) A hydrogen source to gasify silicon and alloys such as atomic hydrogen by plasma and hydrogen ion by electrochemical cells;
Means of supplying hydrogen sources and silicon sources to the reactor chamber;
e) a quench unit
f) an internal heating unit
g) a co-purification unit
bulk, a silicon rod, a stream of silicon powder, melt, vapor, suspension in liquid molten salts, and any form of solid, liquid or vapor silicon;
Means of loading the catalyst to silicon and alloys;
Means of quenching the gas existing in the said reaction chamber;
Means of co-purifying the silane mixture after quenching of the product gas mixture; and optionally
Means of recycling catalyst and hydrogen and inert gas recovered in the process at the end of the process.

18. The system of claim 16, wherein the reaction chamber is selected from packed bed, spouted bed, fluidized bed, moving bed of the silicon powder, and stirred bed or ticking bed for the melt.

19. The reactor of claim 16, wherein the gasification chamber is lined with a refractory material capable of withstanding the gasification temperature.

20. The reactor of claim 16 is further equipped with an internal heating unit surrounding the reaction chamber.
